(19) United States
(12) Patent Application Publication
(10) Pub. No.: US 2010/0090549 A1
(43) Pub. Date: Apr. 15, 2010

(54) THERMAL MANAGEMENT IN A FAULT TOLERANT PERMANENT MAGNET MACHINE

(75) Inventors: William Dwight Gerstler, Niskayuna, NY (US); Xiaochun Shen, Schenectady, NY (US); Ayman Mohamed Fawzi El-Refaie, Niskayuna, NY (US); John Michael Kern, Rexford, NY (US); Manoj Ramprasad Shah, Latham, NY (US); Jeremy Daniel VanDam, West Coxsackie, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/249,626

(22) Filed: Oct. 10, 2008

(51) Int. Cl. H02K 3/24; H02K 15/12

(52) U.S. Cl. 310/58; 29/596

(57) ABSTRACT

A PM machine is provided. The PM machine includes a stator including a stator core, wherein the stator core defines multiple step-shaped stator slots. The stator includes multiple fractional-slot concentrated windings wound within the step-shaped stator slots. The stator also includes at least one cooling tube disposed around the windings. The stator further includes a first insulation layer disposed around the cooling tube. The stator also includes a second insulation layer disposed around the first insulation layer. The stator further includes at least one slot wedge configured to close an opening of a respective one of the step-shaped stator slots, wherein the slot wedge is further configured to adjust a leakage inductance in the PM machine. The PM machine also includes a rotor having a rotor core and disposed outside and concentric with the stator, wherein the rotor core includes a laminated back iron structure disposed around multiple magnets.

### CROSS REFERENCE TO RELATED APPLICATIONS

This application is related to the following co-pending U.S. patent application Ser. No. {Attorney Docket No. 228153-1}, entitled “IMPROVED FAULT TOLERANT PERMANENT MAGNET MACHINE” assigned to the same assignee as this application and filed herewith, the entirety of which is incorporated by reference herein.

### BACKGROUND

The invention relates generally to permanent magnet (PM) machines, such as electric generators and/or electric motors. Particularly, this invention relates to fault tolerant PM machines.

Many new aircraft systems are designed to accommodate electrical loads that are greater than those on current aircraft systems. The electrical system specifications of commercial airliner designs currently being developed may demand up to twice the electrical power of current commercial airliners. This increased electrical power demand must be derived from mechanical power extracted from the engines that power the aircraft. When operating an aircraft engine at relatively low power levels, e.g., while idly descending from altitude, extracting this additional electrical power from the engine mechanical power may reduce the ability to operate the engine properly.

Traditionally, electrical power is extracted from the high-pressure (HP) engine spool in a gas turbine engine. The relatively high operating speed of the HP engine spool makes it an ideal source of mechanical power to drive the electrical generators connected to the engine. However, it is desirable to draw power from additional sources within the engine, rather than rely solely on the HP engine spool to drive the electrical generators. The LP engine spool provides an alternate source of power transfer, however, the relatively lower speed of the LP engine spool typically requires the use of a gearbox, as slow-speed electrical generators are often larger than similarly rated electrical generators operating at higher speeds.

PM machines (or generators) are a possible means for extracting electric power from the LP spool. However, aviation applications require fault tolerance, and as discussed below, PM machines can experience faults under certain circumstances and existing techniques for fault tolerant PM generators suffer from drawbacks, such as increased size and weight.

As is known to those skilled in the art, electrical generators may utilize permanent magnets (PM) as a primary mechanism to generate magnetic fields of high magnitudes for electrical induction. Such machines, also termed PM machines, are formed from other electrical and mechanical components, such as wiring or windings, shafts, bearings and so forth, enabling the conversion of electrical energy from mechanical energy, where in the case of electrical motors the converse is true. Unlike electromagnets, which can be controlled, e.g., turned on and off, by electrical energy, PMs always remain on, that is, magnetic fields produced by the PM persist due to their inherent ferromagnetic properties. Consequently, should an electrical device having a PM experience a fault, it may not be possible to expediently stop the device because of the persistent magnetic field of the PM causing the device to keep operating. Such faults may be in the form of fault currents produced due to defects in the stator windings or mechanical faults arising from defective or worn-out mechanical components disposed within the device. Hence, the inability to control the PM during the above mentioned or other related faults may damage the PM machine and/or devices coupled thereto.

Further, fault-tolerant systems currently used in PM machines substantially increase the size and weight of these devices limiting the scope of applications in which such PM machines can be employed. Moreover, such fault tolerant systems require cumbersome designs of complicated control systems, substantially increasing the cost of the PM machine.

Accordingly, there is a need for an improved fault tolerant PM machine.

### BRIEF DESCRIPTION

In accordance with an embodiment of the invention, a PM machine is provided. The PM machine includes a stator including a stator core, wherein the stator core defines multiple step-shaped stator slots. The stator includes multiple fractional-slot concentrated windings wound within the step-shaped stator slots. The stator also includes at least one cooling tube disposed around the windings. The stator further includes a first insulation layer disposed around the cooling tube. The stator also includes a second insulation layer disposed around the first insulation layer. The stator further includes at least one slot wedge configured to close an opening of a respective one of the step-shaped stator slots, wherein the slot wedge is further configured to adjust a leakage inductance in the PM machine. The PM machine also includes a rotor having a rotor core and disposed outside and concentric with the stator, wherein the rotor core includes a laminated back iron structure disposed around multiple magnets.

In accordance with another embodiment of the invention, a PM machine is provided. The PM machine includes a stator including a stator core, wherein the stator core defines multiple step-shaped stator slots. The stator includes multiple fractional-slot concentrated windings wound within the step-shaped stator slots. The stator also includes a first insulation layer disposed around each turn of the windings. The stator also includes a second insulation layer disposed around the first insulation layer. The stator further includes at least one cooling tube disposed between the first insulation layer and the second insulation layer. The stator also includes at least one slot wedge configured to close an opening of a respective one of the step-shaped stator slots, wherein the slot wedge is further configured to adjust a leakage inductance in the PM machine. The PM machine also includes a rotor having a rotor core and disposed outside and concentric with the stator, wherein the rotor core includes a laminated back iron structure disposed around multiple magnets.

In accordance with another embodiment of the invention, a PM machine is provided. The PM machine includes a stator including a stator core, wherein the stator core defines multiple step-shaped stator slots. The stator includes multiple fractional-slot concentrated windings wound within the step-shaped stator slots. The stator also includes a first insulation layer disposed around each turn of the windings. The stator further includes a second insulation layer disposed around the first insulation layer. The stator also includes at least one cooling tube disposed on an exterior side of the second insulation layer. The stator also includes at least one slot wedge configured to close an opening of a respective one of the step-shaped stator slots, wherein the slot wedge is further configured to adjust a leakage inductance in the PM machine. The PM machine also includes a rotor having a rotor core and disposed outside and concentric with the stator, wherein the rotor core includes a laminated back iron structure disposed around multiple magnets.

In accordance with another embodiment of the invention, a method for forming at least one cooling tube in a PM machine is disclosed. The method includes using an insert to form at least one cooling tube; wherein the step of using the insert includes performing vacuum pressure impregnation (VPI) to deposit a resin in the mold and around the insert for attaching multiple wires. The method also includes curing the resin. The method further includes removing the insert such that the cured resin defines the at least one cooling tube

### DRAWINGS

These and other features, aspects, and advantages of the present invention will become better understood when the following detailed description is read with reference to the accompanying drawings in which like characters represent like parts throughout the drawings, wherein:

FIG. 1 is a diagrammatic illustration of a PM machine in accordance with an embodiment of the invention;

FIG. 2 is a magnified view of stator slots in the PM machine in FIG. 1 illustrating magnetic flux density distribution;

FIG. 3 is a sectional view of the coil windings in the PM machine in FIG. 1 including insulation layers in accordance with an embodiment of the invention;

FIG. 4 is a flow chart representing steps in a method of manufacturing a PM machine in accordance with an embodiment of the invention;

FIG. 5 is a schematic illustration of an exemplary PM machine including cooling tubes as a mechanism for thermal management in accordance with an embodiment of the invention;

FIG. 6 is a schematic illustration of another exemplary cooling arrangement for the PM machine in accordance with an embodiment of the invention;

FIG. 7 is a schematic illustration of yet another exemplary cooling arrangement for the PM machine in accordance with an embodiment of the invention; and

FIG. 8 is a flow chart representing steps in a method for forming cooling tubes in a PM machine in accordance with an embodiment of the invention.

### DETAILED DESCRIPTION

As discussed in detail below, embodiments of the invention are directed to fault tolerant permanent magnet machines. As used herein, the term ‘fault tolerant’ refers to magnetic and physical decoupling between various machine coils/phases while reducing noise, torque ripple, and harmonic flux components. In addition the improved fault tolerant PM machines has high power density and efficiency. Furthermore, embodiments of the machine configuration increase inductance in order to reduce fault current and provide desirable voltage regulation.

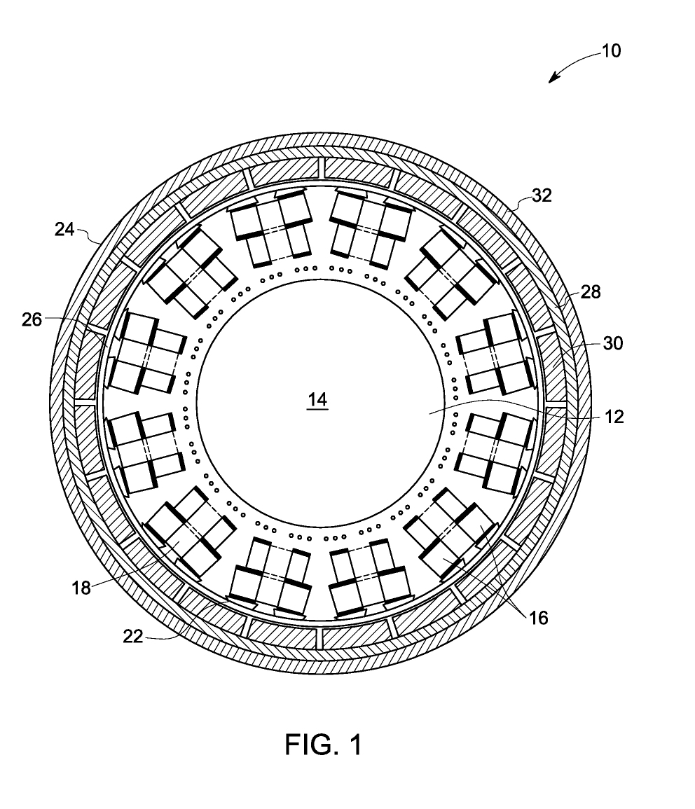

FIG. 1 is a diagrammatic illustration of a permanent magnet (PM) machine 10. The PM machine 10 includes a stator 12 having a stator core 14. The stator core 14 defines multiple step-shaped stator slots 16 including multiple fractional-slot concentrated windings 18 wound within the step-shaped stator slots 16. The fractional-slot concentrated windings provide magnetic and physical decoupling between various phases and coils of the PM machine 10. In the illustrated embodiment, the step-shaped stator slots 16 have a two step configuration. In other embodiments, the step-shaped stator slots 16 may include more than two steps. In a particular embodiment, the fractional-slot concentrated windings 18 are wound radially inward on a first step of the two-step configuration and radially outward on a second step of the two-step configuration. In another embodiment, the fractional-slot concentrated windings comprise multiple Litz wires.

At least one slot wedge 22 closes an opening of a respective one of the step-shaped stator slots 16. This enables adjusting the leakage inductance in the PM machine 10. In an example, the leakage inductance is in a range between about 100 □H to about 110 □H. In one embodiment, the slot wedge includes an iron epoxy resin. Other suitable slot wedge materials, include without limitation, nonmagnetic materials, ceramics, and epoxy. A rotor 24 including a rotor core 26 is disposed outside and concentric with the stator 12. In one embodiment, the rotor core 26 includes multiple axial segments that are electrically insulated from each other to reduce eddy current losses. The rotor core 26 includes a laminated back iron structure 28 disposed around multiple magnets 30. The magnets are also axially-segmented to reduce eddy current losses. In one non limiting example, each magnet includes one hundred (100) segments. The back iron structure 28 is laminated in order to reduce the eddy current losses due to undesirable harmonic components of magnetic flux generated in the stator 12. In a particular embodiment, the PM machine 10 includes at least one retaining ring 32 disposed around the back iron structure 28 to retain the magnets 30. In a non-limiting example, the retaining ring 32 comprises carbon fiber. Other suitable retaining ring materials, include without limitation, Inconel, and carbon steel. In another embodiment, the retaining ring 32 is preloaded to minimize fatigue effects and extend life of the rotor 24. In yet another embodiment, the PM machine 10 has a power density in a range between about 1.46 kW/Kg to about 1.6 kW/Kg. In the illustrated embodiment, the PM machine 10 is an inside out configuration, wherein the rotor 24 rotates outside the stator 12. In other embodiments, the rotor 24 may be disposed inside the stator 12. In yet other embodiments, the machine 10 may include multiple number of phases.

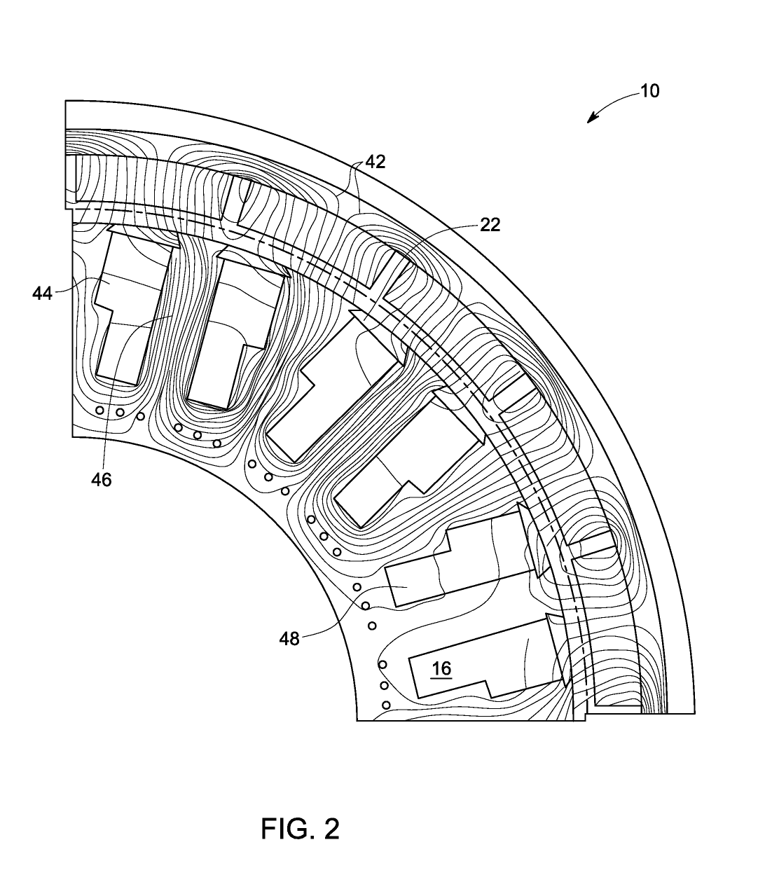

FIG. 2 is a magnified view of the stator slots 16 (FIG. 1) illustrating magnetic flux density distribution 42. As illustrated herein, stator teeth 44 that are wound by coils 46 and stator teeth 48 that are not wound, are subjected to similar magnetic flux densities indicating desirable utilization of copper of the windings and iron of the laminated back iron compared to traditional stator slot configurations. This improves machine power density. Furthermore, in order to simplify manufacturing and maximizing slot utilization, the PM machine 10 has open slots 16 (FIG. 1) such that coils 46 may be dropped inside the slots. The slots 52 are closed via the slot wedge 22, as referenced and illustrated in FIG. 1.

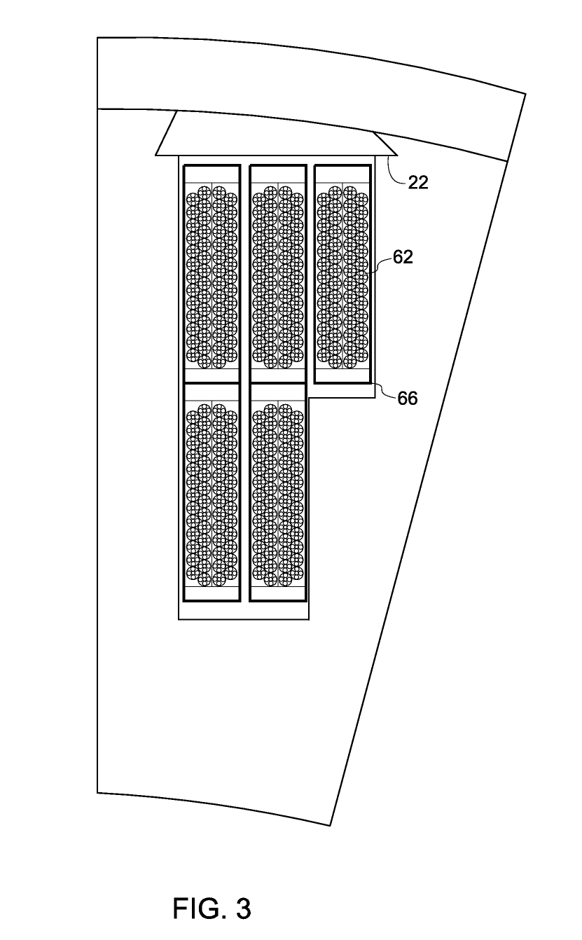

FIG. 3 is a sectional view of coil windings 62 illustrating insulation to reduce possibility of turn to turn fault occurrence. Windings 62 include several bundles of strands (not shown). In one embodiment, the windings 62 are multiple Litz wires. A layer of insulation, also referred to as ‘strand insulation’, is wrapped around each strand. Further, another insulation layer (not shown) may be coated around each of the windings 62. A ground wall insulation 66 is also applied circumferentially around the windings 62. The ground wall insulation 66 reduces possibility of a turn-turn fault, consequently increasing machine reliability. In a particular embodiment, the ground wall insulation 66 includes mica and/or a polyimide. In a non-limiting example, the polyimide is Kapton®.

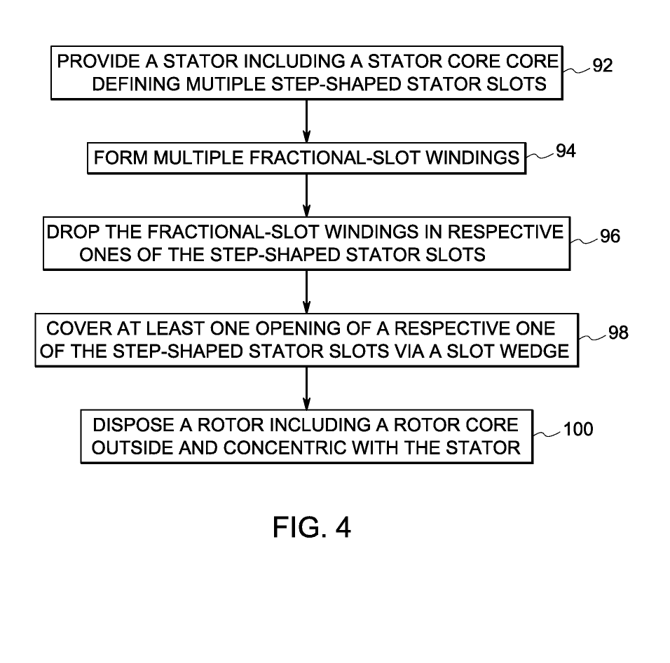

FIG. 4 is a flow chart representing steps in a method of manufacturing a PM machine. The method includes providing a stator including a stator core defining multiple step-shaped stator slots in step 92. In a particular embodiment, the step-shaped stator slots have a two step configuration. The method also includes forming multiple fractional-slot windings in step 94. The fractional-slot windings are dropped in respective ones of the step-shaped stator slots in step 96. In one embodiment, step 94 comprises wrapping the windings radially inward on a first step of the two step configuration and radially outward on a second step of the two step configuration. At least one opening of a respective one of the step-shaped stator slots is covered via a slot wedge in step 98. A rotor including a rotor core is disposed outside and concentric with the stator in step 100. The rotor core includes a laminated back iron structure disposed around multiple axially-segmented magnets. In a particular embodiment, the rotor core includes multiple axial segments. In another embodiment, at least one retaining ring is disposed around the back iron structure. In embodiments wherein multiple retaining rings are employed, there exists a net reduction in total sleeve thickness due to desirable material utilization.

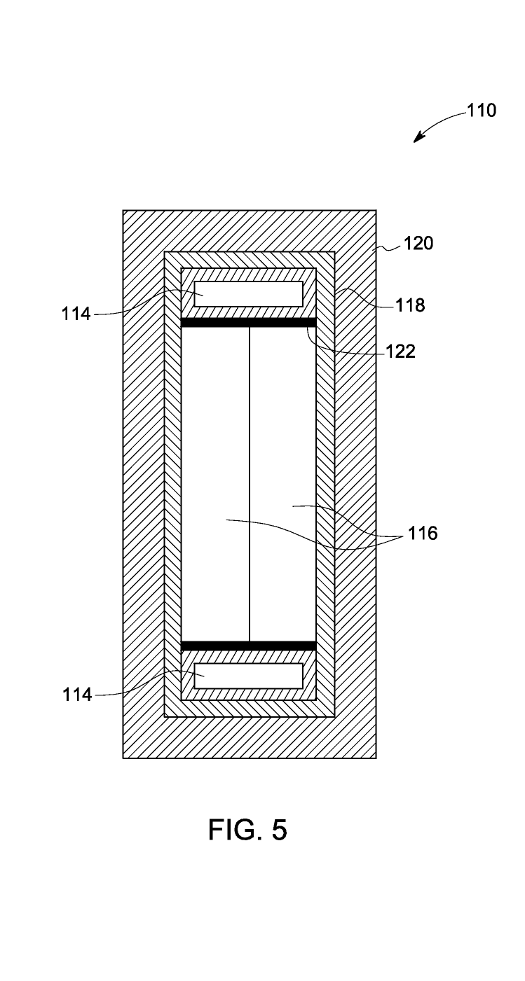

FIG. 5 is a schematic illustration of an exemplary PM machine 110 including cooling tubes 114 as a mechanism for thermal management. In the illustrated embodiment, the cooling tubes 114 are disposed around fractional slot concentrated windings 116. In a particular embodiment, the windings 116 are Litz wires. A first insulating layer 118 is disposed around the cooling tubes 114. Furthermore, a second insulating layer 120 is disposed around the first insulating layer 118. In one embodiment, the first insulating layer 118 and the second insulating layer 120 are formed of at least one of mica or polyimide. An epoxy resin layer 122 attaches the cooling tubes 114 to the windings 116. In a particular embodiment, a third insulating layer such as, but not limited to, mica ‘mush’ is disposed around an outer layer of the windings 116 at a location at which the windings 116 exit the stator core, in order to reduce electrical stress at a point of location.

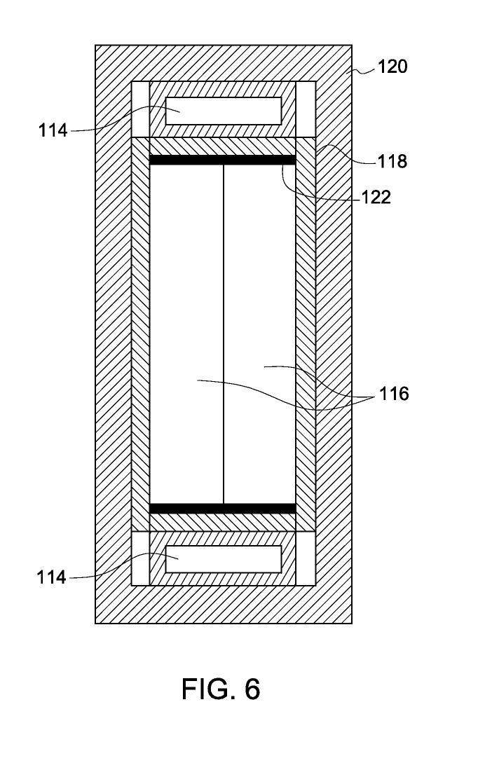

FIG. 6 is a schematic illustration of another exemplary cooling arrangement for a PM machine. In the illustrated embodiment, the cooling tubes 114 (FIG. 5) are disposed between the first insulating layer 118 and the second insulating layer 120. The first insulating layer 118 is disposed around the windings and attached to the windings via an epoxy resin layer 122. The first insulation layer provides a degree of electrical isolation between the winding 116 and the cooling tubes 114, which may be electrically conductive. This minimizes the potential for shorting along the winding 116. In addition, at the core end, the first layer of insulation 118 does not have to be broken to allow an opening for the cooling tubes 114 to be exposed to the cooling fluid and/or connect to a cooling manifold. This also reduces the potential for electrical breakdown issues. While more robust electrically, the first layer of insulation 118 between the winding 116 and cooling tubes 114 will increase the thermal resistance between the winding 116 and a coolant. In a particular embodiment, a third insulating layer such as, but not limited to, mica ‘mush’ is disposed around an outer layer of the windings 116 at a location at which the windings 116 exit the stator core in order to reduce electrical stress at a point of transition.

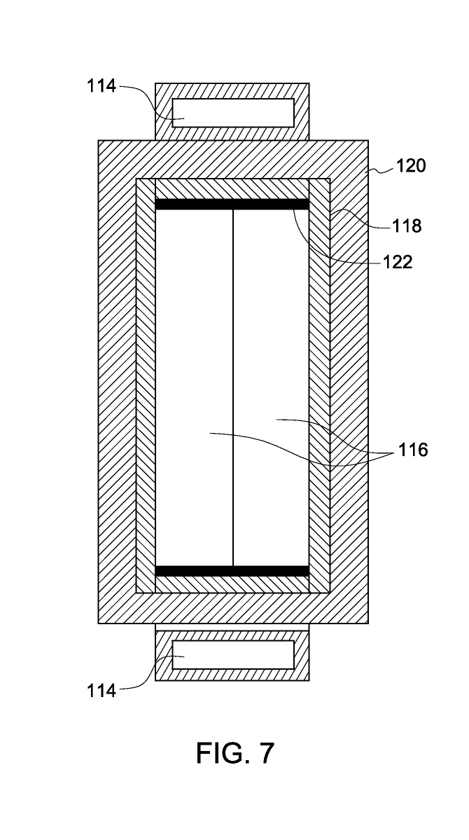

FIG. 7 is a schematic illustration of another exemplary cooling arrangement for a PM machine. In the illustrated embodiment, the cooling tubes 114 (FIG. 5) are disposed on an exterior side of the second insulating layer 120. The first insulating layer 118 is disposed around the windings and attached to the windings via an epoxy resin layer 122. The first and second insulation layers provides a degree of electrical isolation between the winding 116 and the cooling tubes 114, which may be electrically conductive, that is even greater than that provided by the configuration in FIG. 6. This further minimizes the potential for shorting along the winding. In addition, at the core end, the first layer and second layer of insulation does not have to be broken to allow an opening for the cooling tube to be exposed to the cooling fluid and/or connect to a cooling manifold. This further reduces the potential for electrical breakdown issues beyond the reduction for the embodiment shown in FIG. 6. While more robust electrically, the first layer of insulation 118 and second layer of insulation 120 between the winding 116 and cooling tubes 114 will increase the thermal resistance between the winding 116 and a coolant. In one embodiment, a third insulating layer, also referred to, as a ‘slot liner’ may be disposed around walls of the stator slots. In another embodiment, a fourth insulating layer, such as, but not limited to, Kapton® may be wrapped around the cooling tubes 114.

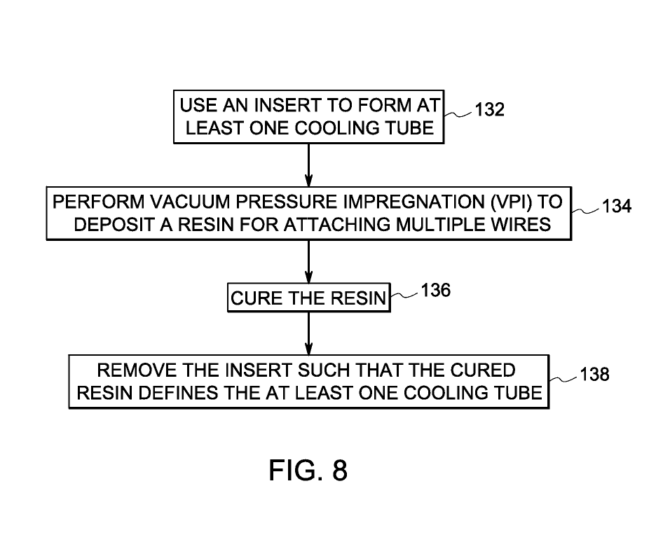

FIG. 8 is a flow chart representing steps in a method for forming cooling tubes in a PM machine. The method includes using an insert to form at least one cooling tube in step 132. In a particular embodiment, vacuum pressure impregnation is performed in step 134 to deposit a resin for attaching multiple wires. The resin is cured in step 136. The insert is removed in step 138 such that the cured resin defines the at least one cooling tube.

PM machines, as described above, may be employed in a variety of applications. One of them includes aviation applications, such as in aircraft engines. Particularly, the PM machines may be a PM generator used for generating supplemental electrical power from a rotating member, such as a low pressure (LP) turbine spool, of a turbofan engine mounted on an aircraft. The PM machines can also be used for other non-limiting examples such as traction applications, wind and gas turbines, starter-generators for aerospace applications, industrial applications and appliances.

The various embodiments of a PM machine described above thus provide a way to provide a PM machine with high power density, reliability and fault tolerance. The PM machine also allows for an innovative thermal management arrangement that enables improved power density. Furthermore, the PM machine operates with minimal noise, vibrations, eddy current losses and torque ripple even at high operating speeds and high operating temperatures. These techniques and systems also allow for highly efficient permanent magnet machines.

Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

Furthermore, the skilled artisan will recognize the interchangeability of various features from different embodiments. For example, the use of an axially segmented rotor core described with respect to one embodiment can be adapted for use with a two-step stator slot configuration described with respect to another. Similarly, the various features described, as well as other known equivalents for each feature, can be mixed and matched by one of ordinary skill in this art to construct additional systems and techniques in accordance with principles of this disclosure.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A permanent magnet machine comprising:
a stator comprising a stator core, the stator core defining a plurality of step-shaped stator slots and comprising:
a plurality of fractional-slot concentrated windings wound within the step-shaped stator slots;
at least one cooling tube disposed around the windings;
a first insulation layer disposed around the cooling tube;
a second insulation layer disposed around the first insulation layer; and
at least one slot wedge configured to close an opening of a respective one of the step-shaped stator slots, the slot wedge being further configured to adjust a leakage inductance in the permanent magnet machine; and
a rotor comprising a rotor core and disposed outside and concentric with the stator, wherein the rotor core comprises a laminated back iron structure disposed around a plurality of magnets.

2. The machine of claim 1, further comprising an epoxy resin configured to attach the cooling tube to the windings.

3. The machine of claim 1, wherein each of the step-shaped stator slots has a two step configuration.

4. The machine of claim 1, wherein the fractional-slot concentrated windings are wound radially inward on a first step of the two step configuration and radially outward on a second step of the two step configuration.

5. The machine of claim 1, wherein the slot wedge comprises an iron epoxy resin.

6. The machine of claim 1, wherein the fractional-slot concentrated windings comprise a plurality of Litz wires.

7. The machine of claim 1, wherein the first insulating layer and the second insulating layer comprise at least one of mica and a polyimide.

8. The machine of claim 1, wherein the magnets are axially segmented.

9. The machine of claim 1, wherein the at least one cooling tube comprises metal, ceramic or a cured resin.

10. The machine of claim 1, further comprising at least one retaining ring disposed around the back iron structure.

11. The machine of claim 10, wherein the retaining ring comprises a material selected from the group consisting of carbon fiber, inconel, carbon steel and combinations thereof.

12. The machine of claim 1, wherein a third insulating layer is disposed around an outer layer of the windings at a location at which the windings exit the stator core.

13. A permanent magnet machine comprising:
a stator comprising a stator core, the stator core defining a plurality of step-shaped stator slots and comprising:
a plurality of fractional-slot concentrated windings wound within the step-shaped stator slots;
a first insulation layer disposed around each turn of the windings;
a second insulation layer disposed around the first insulation layer;
at least one cooling tube disposed between the first insulation layer and the second insulation layer; and
a slot wedge configured to close at least one opening of a respective one of the plurality of stator slots, the slot wedge configured to adjust a leakage inductance in the machine; and
a rotor comprising a rotor core and disposed outside and concentric with the stator, wherein the rotor core comprises a laminated back iron structure around a plurality of magnets.

14. The machine of claim 13, further comprising an epoxy resin configured to attach the first insulation layer to the windings.

15. The machine of claim 13, wherein each of the step-shaped stator slots has a two step configuration.

16. The machine of claim 13, wherein the fractional-slot concentrated windings are wound radially inward on a first step of the two step configuration and radially outward on a second step of the two step configuration.

17. The machine of claim 13, wherein the slot wedge comprises an iron epoxy resin.

18. The machine of claim 13, wherein the fractional-slot concentrated windings comprise a plurality of Litz wires.

19. The machine of claim 13, wherein the first insulating layer and the second insulating layer comprise at least one of mica and a polyimide.

20. The machine of claim 13, wherein a third insulating layer is disposed around an outer layer of the windings at a location at which the windings exit the stator core.

21. A permanent magnet machine comprising:
a stator comprising a stator core defining a plurality of step-shaped stator slots, the stator core comprising:
a plurality of fractional-slot concentrated windings wound within a plurality of stator slots;
a first insulation layer disposed around each turn of the windings;
a second insulation layer disposed around the first insulation layer; and
at least one cooling tube disposed on an exterior side of the second insulation layer; and
a slot wedge configured to close at least one opening of a respective one of the plurality of stator slots, the slot wedge configured to adjust a leakage inductance in the machine; and
a rotor comprising a rotor core and disposed outside and concentric with the stator, wherein the rotor core comprises a laminated back iron structure around a plurality of magnets.

22. The machine of claim 21, further comprising an epoxy resin configured to attach the first insulation layer to the windings.

23. The machine of claim 21, wherein each of the step-shaped stator slots has a two step configuration.

24. The machine of claim 21, wherein the fractional-slot concentrated windings are wound radially inward on a first step of the two step configuration and radially outward on a second step of the two step configuration.

25. The machine of claim 21, wherein the slot wedge comprises an iron epoxy resin.

26. The machine of claim 21, wherein the fractional-slot concentrated windings comprise a plurality of Litz wires.

27. The machine of claim 21, wherein the first insulating layer and the second insulating layer comprise at least one of mica and a polyimide.

28. The machine of claim 21, wherein a third insulating layer is disposed along walls of the stator slots and a fourth insulating layer is disposed around the at least one cooling tube.

29. A method for forming at least one cooling tube in a permanent magnet machine comprising:
using an insert to form at least one cooling tube; wherein the step of using the insert comprises:
performing vacuum pressure impregnation (VPI) to deposit a resin in a mold and around the insert for attaching a plurality of wires;
curing the resin; and
removing the insert such that the cured resin defines the at least one cooling tube.
